(19) United States
(12) Patent Application Publication
(10) Pub. No.: US 2025/0321686 A1
(43) Pub. Date: Oct. 16, 2025

(54) AUTOMATIC KEY CLEANUP TO BETTER UTILIZE KEY TABLE SPACE USING ARTIFICIAL INTELLIGENCE AND MACHINE LEARNING

(71) Applicant: Dell Products L.P., Round Rock, TX (US)

(72) Inventors: Mahadev Karadigudda, San Jose, CA (US); Madhu Agrahara Gopalakrishna, Pleasanton, CA (US); Sankalp Suhas Taralekar, Santa Clara, CA (US)

(21) Appl. No.: 18/632,962

(22) Filed: Apr. 11, 2024

(51) Int. Cl. G06F 3/06

(52) U.S. Cl. CPC G06F 3/0626; G06F 3/0629; G06F 3/0673

(57) ABSTRACT

Automatic key management operations are disclosed. Key tables are used to manage keys used in encryption/decryption operations performed in a data protection operation. A machine learning model is trained to determine when live data associated with each of the keys will reach a threshold. The model, or another model, may also predict disk usage percentage (ingest rates) and associated times such that a quiet period for performing key management operations and/or garbage collection operations can be performed. Thus, once data associated with a key is moved out of that key, the key table space can be optimized by deleting the key during the quite time.

### RELATED APPLICATIONS

This application is related to U.S. Ser. No. 17/722,560 filed Apr. 18, 2022 and entitled AUTOMATIC KEY CLEANUP TO BETTER UTILIZE KEY TABLE SPACE, which application is incorporated by reference in its entirety (hereinafter KEY CLEANUP).

### TECHNOLOGICAL FIELD OF THE DISCLOSURE

Embodiments disclosed herein generally relate to managing keys associated with data encryption. More particularly, at least some embodiments relate to systems, hardware, software, computer-readable media, and methods for rotating encryption keys and scheduling/performing garbage collection operations to reclaim storage and/or reclaiming key table space.

### BACKGROUND

Current key-based encryption systems encode or encrypt data such that the data can only be accessed or decrypted by a user with the correct encryption key. The longer that a particular key is in use, the more susceptible the key is to compromise due to hacking, inadvertent disclosure, or other reasons. While encrypting data at rest, a storage system can obtain encryption keys from one of the several supported key managers. For security reasons, users rotate encryption keys to prevent too much data from being encrypted with a single key.

Users are typically provided options to automatically rotate keys periodically by setting up a key rotation policy. For example, keys may be rotated using time based schedules (e.g., weekly or monthly) or data based schedules (e.g., every 1 Terabyte). The assumption is that keys will be rotated at that frequency. To ensure consistent security, it is important for storage systems to rotate encryption keys at the defined key rotation intervals. If keys are not rotated with sufficient frequency, a large amount of data may be encrypted using a single key, which can expose the data to security vulnerabilities if that single key is compromised.

Frequent key rotation periods (e.g., daily or weekly) can ensure that manageable subsets of data are encrypted with different keys. However, with an aggressive key rotation policy, many keys will be created in the system over a long period of time. Managing many encryption keys can often lead to resource consumption and difficult management. Moreover, a larger key set takes longer to synchronize with an external key manager such as one that uses the Key Management Interoperability Protocol (KMIP). Exporting and importing keys also adds processing overhead if there are large number of keys in the system.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of a distributed storage system including a data protection system;

FIG. 2 discloses aspects of performing data protection operations in or by a data protection system;

FIG. 3 discloses additional aspects of garbage collection operations and key management operations in storage systems including, but not limited to, deduplicated storage environments;

FIG. 4 discloses aspects of a key table configured for managing keys in a data protection system;

FIG. 5 discloses aspects of a key management operation and aspects of a subsequently performed garbage collection operation;

FIG. 6 discloses aspects of machine learning based key management operations;

FIG. 7 discloses aspects of methods for training, predicting, and/or validating predictions used in key management and garbage collection operations; and

FIG. 8 discloses aspects of a computing device, system, or entity.

### DETAILED DESCRIPTION OF SOME EXAMPLE EMBODIMENTS

Embodiments disclosed herein generally relate to key management operations including automatic key rotation operations and automatic key clean-up operations. More particularly, at least some embodiments relate to systems, hardware, software, computer-readable media, and methods for key management operations and garbage collection operations. Embodiments of the invention are discussed in the context of storage systems and data protection systems, examples of which include DELL POWERPROTECT or DATADOMAIN.

Data protection systems, in accordance with embodiments of the invention, often provide encryption services. Because encrypting all of a client's data with the same key may cause problems, key management is typically performed. Key management includes at least key rotation operations and key deletion operations. Key rotation operations typically refer to a process of changing the key used to encrypt new data. For example, a key rotation policy may require a new key to be used according to a periodic schedule. The key rotation policy reduces the amount of data that is encrypted with any one key and allows older keys to be eventually removed or deleted.

Over time, many keys may be created and key management can become complicated for a variety of reasons. Key deletion operations manage the size of a key table and/or the number of keys being managed.

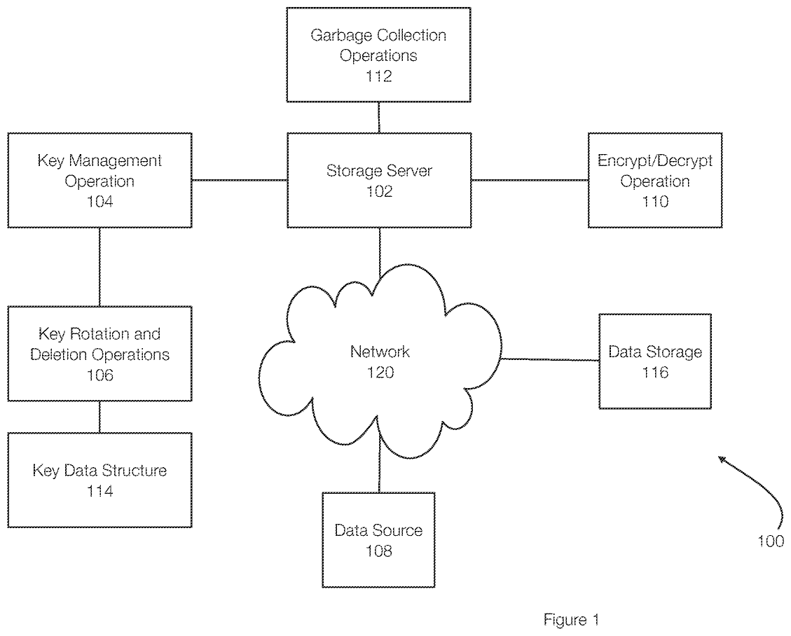

FIG. 1 discloses aspects of a data protection system that includes a storage system that may be configured to perform data protection operations. In one example, the storage server 102 is an example of a data protection system 100 configured to perform data protection operations. In this example, the data protection system 100 is configured to perform data protection operations with respect to data stored in a data source 108, which may be an example of production data. Thus, data from the data source 108 may be backed up to the data storage 116. The data source 108 and the data storage 116 may each include disk drives, volumes, disk arrays, or other storage devices and may be accessible over a network 120 (local area network, Internet, or the like). The data storage 116 may be an integral part of the storage server 102 in one example or may be remote from the storage server 102. The data source 108 and data storage 116 are representative of many different storage configurations including distributed configurations.

In this example and in addition to data protection operations such as backup/restore operations, the storage server 102 may configured to perform various operations including encryption/decryption operations 110 and/or key management operations 104. The key management operations 104 may include key rotation and/or key deletion operations 106. Key management operations are performed to ensure that multiple keys are used to encrypt the data stored in the data storage 116 and to ensure that older keys are deleted once any associated encrypted data is not present (or not valid) in the storage system.

In addition, the storage server 102 may perform garbage collection operations 112. The garbage collection operations 112 may be configured to clean the data storage 116 and/or a key data structure 114. Cleaning, in one example, may refer to deleting data to reclaim storage space and/or deleting keys to manage a key table or to manage keys used in the encryption/decryption operations.

As data is deleted from the data storage 116, some of the keys in a key data structure 114 (e.g., a key table) become unused or stale. As such, a key deletion operation may be performed to remove these keys from the key data structure 114.

In one example, the storage server 102 may use Key Management Interoperability Protocol (KMIP), which defines message formats for the manipulation of keys on a key management server. This facilitates data encryption by simplifying encryption key management. Keys may be created on a server and then retrieved for use. Both symmetric and asymmetric keys are supported, including the ability to sign certificates. KMIP also allows for clients to ask a server to encrypt or decrypt data, without needing direct access to the key. Under KMIP, each key has a cryptographic state. Keys are created in an initial state, and must be activated before they can be used. Keys may then be deactivated and eventually destroyed. A key may also be marked as being compromised. Keys may be generated and stored locally, or they may be provided from an external key source, such as one that implements KMIP to provide keys to key clients.

A key can become compromised due to a variety of reasons. For example, a compromised key can result from the unauthorized disclosure of a key so that all data encrypted by that key could be accessed by unauthorized parties. The integrity of a key could be compromised by invalid modification or substitution so that the key could be used for the wrong purpose or for the wrong application. The key's association with the owner could be compromised so that the identity of the other party cannot be assured or the data cannot be properly decrypted. The key's association with other information can be compromised so that the key is not associated with any data or the wrong data.

In one example, keys are rotated frequently to prevent an excess amount of data being encrypted by a single key. For example, with successful key rotations, 100 TB (terabytes) of data may be encrypted in chunks of 10 TB, each with a different respective encryption key. In the case of key rotation failure, all 100 TB may be encrypted with only one key, thus exposing the entire dataset to vulnerability rather than just one 10 TB chunk.

If a key is compromised, all the data associated with that compromised key should be re-encrypted. If a large amount of data (e.g., 100 TB versus 10 TB) is associated with a single compromised key, a great deal more time will be required to re-encrypt the data. The chance of security vulnerability increases in case of such a delay in re-encrypting that data, which may lead to disruptions in regular backup and restore operations.

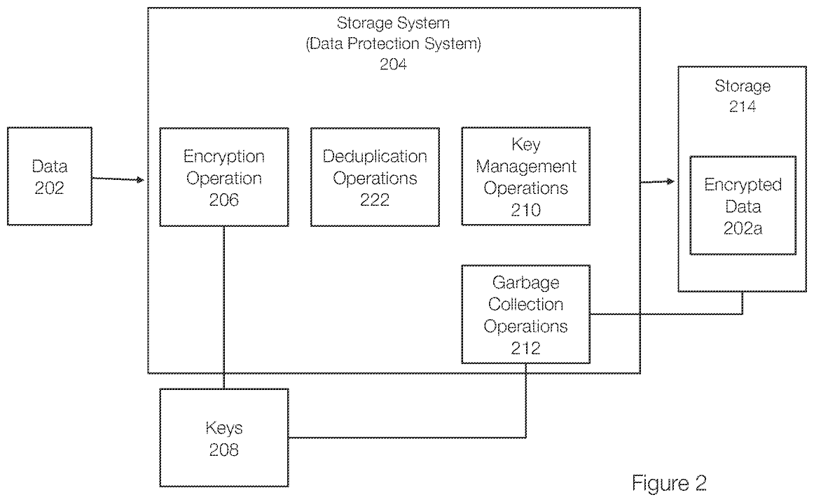

FIG. 2 discloses aspects of key management operations in a data protection system. FIG. 2 illustrates a storage system 204, which is an example of the data protection system 100. The storage system 204 may be a physical or virtual appliance in one example. The storage system 204 may be cloud-based, edge-base, or combinations thereof. In some examples, a storage system 204 on the edge or in an om-premise system may communication or coordinate with a storage system in the cloud.

In this example, the storage system 204 is generally configured to protect data 202 by storing a copy of the data 202 (illustrated as encrypted data 202a) in a storage 214. The encrypted data 202a may represent snapshots, backups, point in time backups, journal data, replicated data, or the like or combinations thereof. The encrypted data 202a can be stored in local (active tier) storage, at the edge, and/or in the cloud.

During data protection operations, such as a backup operation, the storage system 204 may perform various operations on the data 202. For example, an encryption operation 206 may be performed using keys 208. Key management operations 210 may be performed. Key management operations may include key rotation operations, key identification operations, key retrieval operations, key deletion operations, or the like.

The keys 208 may be stored in a key manager that is managed by the storage system 204 or by an external key manager. As previously indicated, in the case of encrypted data, if any key is compromised, data encrypted that compromised keys are at risk.

More specifically, the key management operations 210 include a key rotation operation that may operate in conjunction with at least the encryption operation 206. The key rotation operation uses one or both of a size or time-based rotation policy that tries to ensure that each chunk of data encrypted by a particular key is the same or nearly the same size as the other encrypted chunks to prevent any one key from encrypting an excessive amount of data. Thus, at a given time schedule or at a given data size, the current encryption key is changed to a new current encryption key. Generally, only one key is used at a time to encrypt data.

In this example, the key management operations 210 include key rotation operations and key deletion operations. These operations ensure that key rotation is attempted at key rotation intervals (or at other times) so that roughly equal amounts of data will be encrypted with each key. The key deletion operation ensures that old, unused keys are automatically removed from the key table and system to reduce key storage and management overhead. A key deletion operation may be performed as part of or at the same time as a garbage collection operation. Key deletion operations may also be scheduled for different times.

The storage system 204 also illustrates garbage collection operations 212 that are performed on the data 202a. Because the garbage collection operations 212 may include key management operations, keys subject to deletion may be deleted and a key table may be updated during the garbage collection operations 212. Garbage collection operations 212 may be performed according to a schedule or may be triggered. For example, the data 202a may change over time (e.g., new backups are added). This garbage collection operations allow space in the storage 214 to be reclaimed by deleting old or stale data.

In one example, the storage system 204 may perform deduplication operations 222 such that the storage 214 is a deduplicated storage. Deduplicating data can make garbage collection operations 212 and key management operations 210 more difficult. More specifically, a particular portion of the data 202a cannot simply be deleted because some of the data may relate to newer backups or to backups that are still valid. As long as valid data (data associated with a valid backup) is associated with a key, that key cannot be deleted.

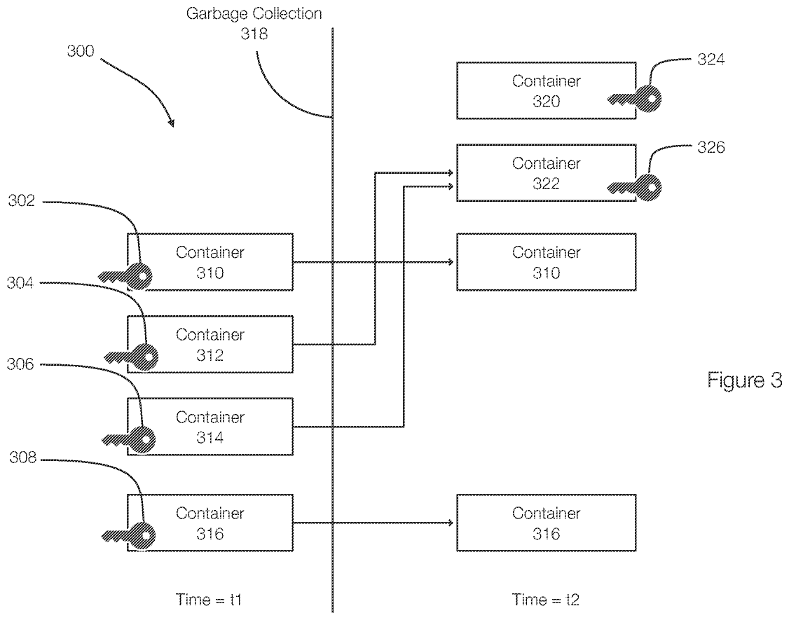

FIG. 3 discloses additional aspects of garbage collection operations and key management operations in storage systems including, but not limited to, deduplicated storage systems. In a deduplicated storage system (or other storage systems), the data may be stored in containers. The containers may store different types of data. For example, some containers may store data while other containers may store recipes or portions or recipes used to reconstitute deduplicated data. For ease of explanation, the containers are referred to as storing data. The sizes of the containers are typically defined and when a container is full, a new container is created and used. Thus, the number of containers in a storage system may increase over time. Data is reclaimed by removing containers that do not store live or valid data. FIG. 3 is described in the context of containers, but other storage schemes are within the scope of embodiments of the invention.

Deleting data in the context of deduplicated data can be complicated. For example, a backup corresponding to a point in time may expire and is subject to deletion. However, the data corresponding to that backup may be stored in multiple containers. Because the data is deduplicated, data associated with a deleted backup may still be part of a live backup. As a result, any given container may include live data (e.g., still part of a valid backup) and dead data (data no longer referenced with a valid or live backup). Over time, however, the percentage of live data in a container decreases. These containers may be subject to garbage collection based on their liveness.

For example, FIG. 3 illustrates a storage system 300 that may be configured to store deduplicated data. In this example, data is stored in containers. FIG. 3 references a time t₁ and at time t₂. This times are points in time and may or may not correspond to a specific operation. A container may represent a portion of storage and may have a particular size (e.g., 100 GB, 1 TB). At time t₁, data is stored in n containers, represented by the containers 310, 312, 314, and 316, in the storage system 300.

FIG. 3 illustrates the implementation of a key rotation policy and/or key deletion policy. Data stored in the container 310 is encrypted with the key 302. Data in the containers 312, 314, and 316 are encrypted, respectively, with encryption keys 304, 306, and 308. A key, however, may be associated with more than one container as key rotation policies are often time or size based.

At some point in time, a reclamation or garbage collection 118 operation is performed. In one example, the garbage collection operation 118 may determine that the containers 312 and 314 should be reclaimed or cleaned. This may cause a consolidation operation to be performed as part of the garbage collection operation 318. The decision to consolidate may be based on the percentage of data in the containers 312 and 314 that is live. Thus, the live data in the containers 312 and 214 may be copied forward into a new container 322 and encrypted with a different key 326, which may be the key currently used for encryption in the storage system 300. After consolidation, the containers 312, 314 may be deleted or marked for deletion. The keys 304 and 306 may also be deleted or marked for deletion as no data is currently encrypted with the keys 304 and 306. There is no change to the containers 310 and 316 during the garbage collection operation 318 in this example.

FIG. 3 illustrates that, at time=t₂, a key rotation (may coincide with a garbage collection operation or not) has been performed and a new container 320 is used to store new data and is encrypted with a new key 324. The key 326 was the current key at the time of the consolidation operation to consolidate the live data in the containers 312 and 314. Once a new key is created, encryption is only performed with that key. In other words, only one key is used to encrypt new data at a given time. Key rotation generates a new current key and the previous current key is no longer used for encryption, but is still associated with encrypted data in the storage system 300.

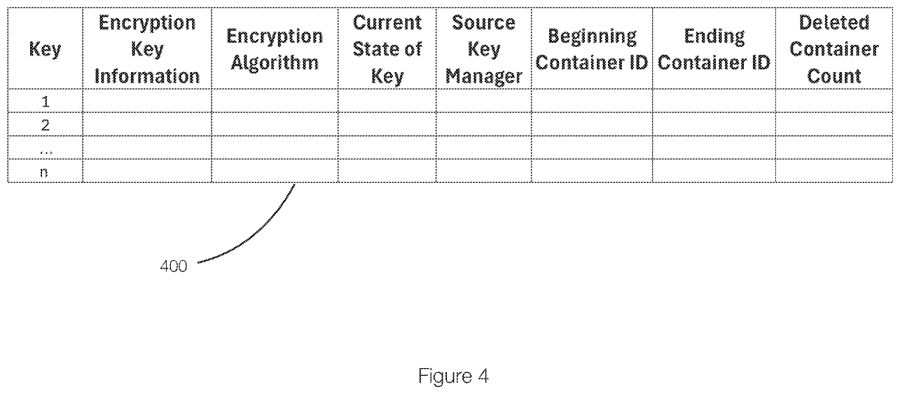

FIG. 4 discloses aspects of a key table configured for managing keys in a storage system. More specifically, the table 400 is an example of a data key encryption table that includes per key information including encryption key algorithm, encryption algorithm, current state of key, source key manager, beginning container ID, ending container ID, and/or delete container count.

During operation of the storage system, a current key (e.g., key (n−1)) is used to encrypt data. At a beginning of a key rotation operation, a new key (e.g., key n) is created and a new container is created. This ensures, for convenience, that data in a particular container is not associated with two keys. For the next key rotation period, all data is encrypted using the key n.

Because a new container is also created along with the new current key n, the identifier of that container is stored in the beginning container ID column for the key n. At the next key rotation, a new key (key (n+1)) is created and the ending container ID for the key n is stored in the table 400. Thus, the number of containers encrypted using the key n can be determined by the difference between the ending container ID and the beginning container ID.

When a container is deleted (or consolidated), for example during a garbage collection operation, the deleted container count for the corresponding key is incremented. When the deleted container count for a given key equals the number of containers encrypted with that key, the storage system should not have any data that was encrypted with that key. Thus, the key can be deleted during a key deletion operation, which may be part of a garbage collection operation.

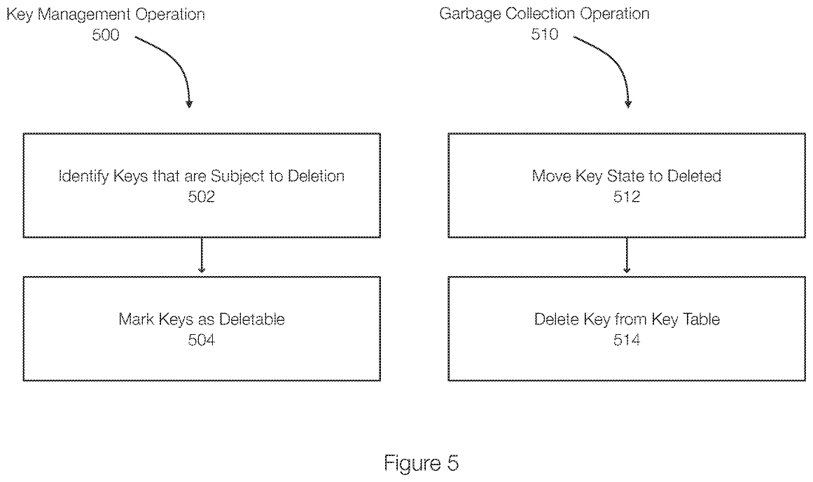

FIG. 5 discloses aspects of deleting or managing keys and aspects of garbage collection. A key deletion operation 500 include identifying 502 keys that are subject to or that may be subject to deletion. In one example, the entries in the key table (e.g., table 400) can be evaluated. In one example, the deleted container count, the beginning container ID, and the ending container ID are used to determine whether the number of containers associated with a key is zero or less than a threshold number. The threshold number may depend on the size of the containers. When the number of containers is 0 or less than the threshold number for a given key, the key is marked 504 as deletable (e.g., in the state of the key in the key table) or deleted. The key may not actually be destroyed at this stage.

During a subsequent garbage collection operation 510, the garbage collection process may move the key state to deleted 512 in the key table. More specifically, the garbage collection operation (or a next garbage collection operation) may verify that no data is encrypted with that key and then delete 514 the key from the key table.

At the time that a key is marked as deletable by the key deletion operation 500, data may still be associated with that key. However, by the time the garbage collection operation 510 is performed, the amount of data associated with that key may be zero. If data is still associated with the key, the key may be deleted during a next garbage collection operation. The method 510 ensures, however, that keys marked as deletable are evaluated and deleted when appropriate. These key management operations manage the number of keys in the key table. In one example, a consolidation operation may be performed such that the key and now stale container can be deleted.

Embodiments of the invention further relate to artificial intelligence/machine learning key management operations. Embodiments of the invention train a model to predict when the amount of data encrypted by a single key will go below a threshold value. The model is trained based on the historical expirations of data or the historical data deletion operations and rates. This prediction allows keys holding an amount of data below a threshold amount to be set on a path for retirement. Once data is moved out of the key (e.g., by deleting data, consolidation operations), the key can be deleted. This will improve usage and management of the key table space.

Embodiments of the invention further relate to scheduling garbage collection operations (and/or key management operations) during a quiet period (e.g., when the system is less busy, other processes such as backup/restore are not occurring, or the like). The quiet period to be used is identified from the point of time the data associated with a key is reducing to a set threshold to the point of time the data associated with the key reaches the threshold in one example.

The quiet period may be identified using, for example, disk performance data and machine learning. This may improve usage of the key table (e.g., allow size/space required for the key table to be managed) and reduce the load on the garbage collection operation at least because a key deletion operation and/or garbage collection operation is occurring in a quiet period.

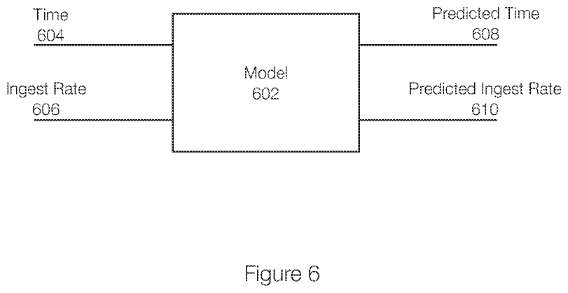

FIG. 6 discloses aspects of a model configured to predict a quiet time, or more specifically, to predict disk performance data and associated times, from which a quiet time may be selected. In FIG. 6, a model 602 is trained using historical data to predict a quiet time. The historical data includes data related to disk usage. For example, some computing or storage systems generate disk performance data. The disk performance data may include disk statistics that are generated on a periodic basis (e.g., every 5 minutes) for an in-use disk. In one example, the disk performance data includes a perf.log generated by DDOS system.

The disk performance data may include disk busy percentage, read iops, write iops, disk names, and the like. In one example, the disk busy percentage may be an example of a parameter to determine or perform an ingest rate analysis. The disk busy percentage, which is recorded periodically in the disk performance data, is an example of time series data that may be associated with timestamps or epochs.

More specifically, the performance data can be used or associated with different usage patterns. In one example, the disk is mapped into a disk name (ssd disk->ssd disk name). With the disk name, tuples can be generated of the following type:
<ssd disk name, time stamp, ingest rate (disk busy %)>.

In one example, the timestamp may represent user times or timestamps that are converted to an epoch time.

The tuples generated from the historical disk performance data may be used to train different machine learning models in order to detect patterns (some model types may perform better than other model types). The trained model 602 may be used to predict future patterns and the patterns may be subsequently validated. The prediction allows a quiet time to be identified.

To determine whether a pattern exists between time and disk busy percentage (or ingest rate), experiments were performed using K-means clustering on a usage pattern that spanned a 7-day usage cycle. Different values of K may be used. By way of example only, in 7-day usage cycles, backups may take place on weekends. As a result, disk utilization percentage (ingest rage) tends to be higher during weekends.

One example of a machine learning model is a linear regression model. This model is based on straight line relationships. Random forest modes are based on decision trees. Random forests attempt to average results by forming smaller decision trees. A long short-term memory (LSTM) model is an example of a recurrent neural network (RNN). One advantage of an RNN is that the RNN can connect previous information to a present task. However, an RNN also has a problem referred to as an exploding or vanishing gradient, which makes it challenging to find long term dependencies of the past and present. In one example, as illustrated in the Appendix which is incorporated by reference, an LSTM model achieved 95% accuracy, while a random forest and a linear regression achieved accuracies of, respectively, 91 and 78 percent.

The model 602 is thus trained to predict a predicted ingest rate 610 (or disk usage percentage) and a predicted time 608 based on an input time 604 and an input ingest rate 606. For example, a data protection system may set a threshold of 10 TB as a key rotation policy. Ten percent of this threshold is 1 TB and key management operations (e.g., key rotation and/or key deletion or key clean up) may be performed when the data threshold is achieved. The model 602 may be configured to determine when the data 1.5 TB (e.g., 1 TB plus a 50% buffer in this example). The data protection system may schedule a garbage collection operation to be performed in a quiet period from the point of time at which the data reaches 1.5 TB and is reducing towards 1 TB. If the model 602 predicts that the data associated with a particular key is going reach 1 TB from 1.5 T in the next 8 days, a garbage collection operation is scheduled to run in a quiet period during the time from which the data associated with the key is 1.5 TB to the point of time the data associated with the key reaches 1 TB.

Thus, the input to the model 602 is a time 604 (time series data) and an ingest rate 606 (time series data) and the output is time series data (predicted time 608) and predicted ingest rate 610 (time series data). A quiet period may be defined as a period in which the predicted ingest rate 610 is below a threshold ingest rate. The garbage collection operation may be performed during the predicted period. Running the garbage collection operation during a quiet period improves utilization of the key table space and lowers the load on the garbage collection runs as the key deletion is occurring during the quiet period.

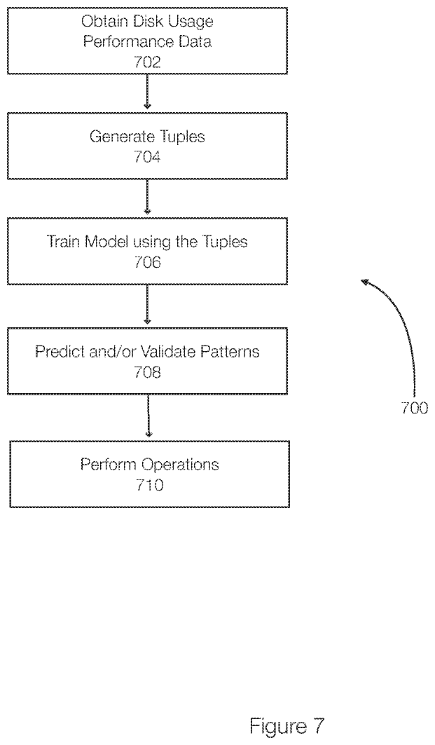

FIG. 7 discloses aspects of methods for training, predicting, and/or validating predictions used in key management and/or garbage collection operations. Aspects of the method 700 may be performed in stages. For example, the method 700 may reflect training, validation, and/or usage/deployment stages, each of which may be performed separately and independently.

The method 700 includes collecting 702 disk usage performance data. In one example, this may be collected from disk logs (e.g., perf.log) and may be represented as disk usage percentage or ingest rates. Disk logs or disk performance data may also be generated to reflect different usage patterns. Next, tuples are generated 704. The tuples, in one example, include a disk name, a time stamp, and an ingest rate. The time stamp may reflect an epoch time generated from user times. The model is trained 706 using the tuples. The model may be validated using validation data (e.g., a reserved portion of the training data).

Once trained, the model may be deployed for use. Thus, the model may predict usage patterns (e.g., times and associated disk performance data or ingest rates). The patterns predicted by the model may be validated. Validation may be performed during usage as well in order to ensure the model is performing satisfactorily. Based on the prediction, operations are performed 710. Performing the operations may include scheduling the operations.

For example, a key deletion operation may be performed at the same time as or may be part of a garbage collection operation. When live data in a container is reducing towards a threshold size threshold, performing the garbage collection operation during a quiet time allows containers to be consolidated and keys to be deleted. The key table may also be managed as described herein.

Embodiments of the invention are not static. For example, if accuracy of the model goes below a threshold on a validation set, this may suggest that the usage pattern has changed and that the model may require retraining. For example, a user may make changes in their computing system such as a headswap, OS changes, upgrades, or the like. Changing network and data patterns may also impact the model accuracy. As a result, embodiments of the invention may dynamically train the model (or retrain the model).

Embodiments of the invention thus relate to cleaning up encryption keys (e.g., the key table) when no data is associated with that key. Data (live data) encrypted with a particular key will go below a threshold size based on the historical expiry of user files/data. Embodiments of the invention help the storage system avoid managing keys that are not associated with encrypted data. A trained model can identify or aid in predicting a quiet period and/or when live data will reach a threshold size. In one example, multiple models may be used (one to predict when data will reach the threshold size and one used to predict the quiet period. A garbage collection operation is scheduled to cleanup a particular key based on the prediction of the model or models. This improves use of a key table and reduces the load on the garbage collection operation in subsequent executions.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, data protection operations, key management operation, key rotation/deletion operations, garbage collection operations, machine learning operations, quite time identification operations, reclamation scheduling/execution operations, or the like. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable perform operations initiated by one or more clients or other elements of the operating environment.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments may be employed include, but are not limited to, Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ is intended to be broad in scope. Example embodiments are applicable to any system capable of storing and handling various types of objects, in analog, digital, or other form.

It is noted that any operations of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.
Embodiment 1. A method comprising: obtaining disk performance data and time data from a storage system, wherein the disk performance data includes a disk usage percentage related to the time data, predicting predicted disk usage percentages and associated predicted times by a model, determining a quiet period from the predicted disk usage percentages and predicted times, and performing an operation during the quiet period on a key table configured to manage keys used in the storage system, wherein each of the keys is associated with encrypted data.
Embodiment 2. The method of embodiment 1, wherein the disk performance data comprises time series disk usage percentage data and the time data comprises time series time data, wherein the disk usage percentage data corresponds to an ingest rate.
Embodiment 3. The method of embodiment 1 and/or 2, wherein the model is trained using historical disk usage percentages and historical times.
Embodiment 4. The method of embodiment 1, 2, and/or 3, wherein the operation is a key deletion operation.
Embodiment 5. The method of embodiment 1, 2, 3, and/or 4, wherein the model is configured to identify a time when data associated with each of the keys reaches a threshold size.
Embodiment 6. The method of embodiment 1, 2, 3, 4, and/or 5, wherein live data associated with a first key is reducing towards a threshold size in the storage system.
Embodiment 7. The method of embodiment 1, 2, 3, 4, 5, and/or 6, wherein the quiet time is between a time at which the size of the live data reaches a threshold size plus a buffer to a time at which the size of the data reaches the threshold size.
Embodiment 8. The method of embodiment 1, 2, 3, 4, 5, 6, and/or 7, wherein the quiet period is associated with a predicted disk usage percentage that is less than a threshold disk usage percentage.
Embodiment 9. The method of embodiment 1, 2, 3, 4, 5, 6, 7, and/or 8, wherein the operation includes a garbage collection operation in the storage system, a key deletion operation, and/or a key rotation operation.
Embodiment 10. The method of embodiment 1, 2, 3, 4, 5, 6, 7, 8, and/or 9, wherein the model is trained using tuples, the tuples including a disk name, a timestamp, and an ingest rate, wherein predictions are based on an input that includes tuples.
Embodiment 11. The method of embodiment 1, 2, 3, 4, 5, 6, 7, 8, 9, and/or 10, further comprising dynamically re-training the model when an accuracy of the model goes below an accuracy threshold.
Embodiment 12. The method of embodiment 1, 2, 3, 4, 5, 6, 7, 8, 9, 10, and/or 11, wherein the operation includes deleting keys from a key table and/or reclaiming space in the storage system.
Embodiment 13. A system, comprising hardware and/or software, operable to perform any of the operations, methods, or processes, or any portion of any of these, disclosed herein.
Embodiment 14. A non-transitory storage medium having stored therein instructions that are executable by one or more hardware processors to perform operations comprising the operations of any one or more of embodiments 1-12.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

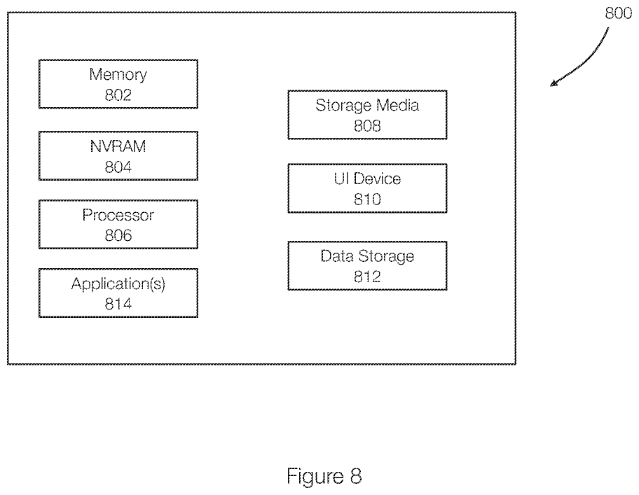

With reference briefly now to FIG. 8, any one or more of the entities disclosed, or implied the Figures and/or elsewhere herein, may take the form of, or include, or be implemented on, or hosted by, a physical computing device, one example of which is denoted at 800. As well, where any of the aforementioned elements comprise or consist of a virtual machine (VM), that VM may constitute a virtualization of any combination of the physical components disclosed in FIG. 8.

In the example of FIG. 8, the physical computing device 800 includes a memory 802 which may include one, some, or all, of random access memory (RAM), non-volatile memory (NVM) 804 such as NVRAM for example, read-only memory (ROM), and persistent memory, one or more hardware processors 806, non-transitory storage media 808, UI device 810, and data storage 812. One or more of the memory components 802 of the physical computing device 800 may take the form of solid state device (SSD) storage. As well, one or more applications 814 may be provided that comprise instructions executable by one or more hardware processors 806 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method comprising:
obtaining disk performance data and time data from a storage system, wherein the disk performance data includes a disk usage percentage related to the time data;
predicting predicted disk usage percentages and associated predicted times by a model;
determining a quiet period from the predicted disk usage percentages and predicted times; and
performing an operation during the quiet period on a key table configured to manage keys used in the storage system, wherein each of the keys is associated with encrypted data.

2. The method of claim 1, wherein the disk performance data comprises time series disk usage percentage data and the time data comprises time series time data, wherein the disk usage percentage data corresponds to an ingest rate.

3. The method of claim 1, wherein the model is trained using historical disk usage percentages and historical times.

4. The method of claim 1, wherein the operation is a key deletion operation.

5. The method of claim 4, wherein the model is configured to identify a time when data associated with each of the keys reaches a threshold size.

6. The method of claim 5, wherein live data associated with a first key is reducing towards a threshold size in the storage system.

7. The method of claim 6, wherein the quiet time is between a time at which the size of the live data reaches a threshold size plus a buffer to a time at which the size of the data reaches the threshold size.

8. The method of claim 7, wherein the quiet period is associated with a predicted disk usage percentage that is less than a threshold disk usage percentage.

9. The method of claim 8, wherein the operation includes a garbage collection operation in the storage system, a key deletion operation, and/or a key rotation operation.

10. The method of claim 1, wherein the model is trained using tuples, the tuples including a disk name, a timestamp, and an ingest rate, wherein predictions are based on an input that includes tuples.

11. The method of claim 1, further comprising dynamically re-training the model when an accuracy of the model goes below an accuracy threshold.

12. The method of claim 1, wherein the operation includes deleting keys from a key table and/or reclaiming space in the storage system.

13. A non-transitory storage medium having stored therein instructions that are executable by one or more hardware processors to perform operations comprising:
obtaining disk performance data and time data from a storage system, wherein the disk performance data includes a disk usage percentage related to the time data;
predicting predicted disk usage percentages and associated predicted times by a model;
determining a quiet period from the predicted disk usage percentages and predicted times; and
performing an operation during the quiet period on a key table configured to manage keys used in the storage system, wherein each of the keys is associated with encrypted data.

14. The non-transitory storage medium of claim 13, wherein the disk performance data comprises time series disk usage percentage data and the time data comprises time series time data, wherein the disk usage percentage data corresponds to an ingest rate, wherein the model is trained using historical disk usage percentages and historical times.

15. The non-transitory storage medium of claim 13, wherein the operation is a key deletion operation.

16. The non-transitory storage medium of claim 15, wherein the model is configured to identify a time when data associated with each of the keys reaches a threshold size.

17. The non-transitory storage medium of claim 16, wherein live data associated with a first key is reducing towards a threshold size in the storage system, wherein the quiet time is between a time at which the size of the live data reaches a threshold size plus a buffer to a time at which the size of the data reaches the threshold size.

18. The non-transitory storage medium of claim 17, wherein the quiet period is associated with a predicted disk usage percentage that is less than a threshold disk usage percentage, wherein the operation includes a garbage collection operation in the storage system, a key deletion operation, and/or a key rotation operation.

19. The non-transitory storage medium of claim 13, wherein the model is trained using tuples, the tuples including a disk name, a timestamp, and an ingest rate, wherein predictions are based on an input that includes tuples, wherein the operation includes deleting keys from a key table and/or reclaiming space in the storage system.

20. The non-transitory storage medium of claim 13, further comprising dynamically re-training the model when an accuracy of the model goes below an accuracy threshold.
